(19) United States
(12) Patent Application Publication
(10) Pub. No.: US 2007/0173589 A1
(43) Pub. Date: Jul. 26, 2007

(54) Thermally conductive fibers and fabrics

(76) Inventor: L.P. Felipe Chibante, Houston, TX (US)

Correspondence Address: Karen B. Tripp;Attorney at Law, P.O. Box 1301, Houston, TX, 77251-1301, US

(21) Appl. No.: 11/656,229

(22) Filed: Jan. 20, 2007

Related U.S. Application Data
(60) Provisional application No. 60/760,536, filed on Jan. 20, 2006.

(51) Int. Cl. C08K 3/04

(52) U.S. Cl. 524/495

(57) ABSTRACT

The present invention involves the production of fibers and fabrics with improved thermal conductivity and thermal stability. The improvement is accomplished by incorporating nanoscale anisotropic materials, that are <500 nm on the minor axis, have aspect ratio (length compared to width) of at least 2, and possess thermal conductivity values >1 W/mK. The invention has been demonstrated in various polymer systems such as but not limited to polyamides, thermoplastic urethanes, polypropylene, polyethylene and other thermoplastics. As well, various fiber production technologies were practiced such as melt spinning (thermo-plastics), dry/wet spinning (elastomerics) and gel spinning (UHMW polyethylene, poly-(p-phenyleneterephtalamide)) to produce said fibers. Fabric woven from said fibers maintains the improved thermal performance and has application in a broad spectrum of thermal management opportunities.

### RELATED APPLICATIONS

This application claims priority to U.S. Provisional Application Ser. No. 60/760,536, filed Jan. 20, 2006, the entirety of which is incorporated herein by reference.

### GOVERNMENT INTERESTS

This invention was made with U.S. Government support under Contract No. NAS 9 02088 between the U.S. (National Aeronautics and Sapce Administration) and NanoTex Corp. of Houston, Tex. The U.S. Government may have certain rights in this invention.

### BACKGROUND OF THE INVENTION

1. Field of the Invention

The present invention relates to the substantial improvement of thermal conductivity and thermal stability of any current fiber manufactured as well as the thermal properties of textiles made from said fibers.

2. Description of Relevant Art

The inventor has developed related prior art (US Patent Application #20060047052 Barrera; EnriqueV; et al., filed Dec. 7, 2000) wherein polymeric nanocomposites composed of embedded nanofibers within polymer systems demonstrated improved physical properties. In related art, the addition of various fillers to polymers to alter thermal conductivity has been described by several inventors (See: U.S. Pat. No. 5,194,480 Block , et al. Thermally conductive elastomer; U.S. Pat. No. 5,523,049 Terpstra, et al. Heat sink and method of fabricating; U.S. Pat. No. 5,925,467 Strumpler, et al. Electrically and thermally conductive plastic and use of this plastic; U.S. Pat. No. 6,090,484 Bergerson, Thermally conductive filled polymer composites for mounting electronic devices and method of application; U.S. Pat. No. 6,114,413 Kang, et al. Thermally conducting materials and applications for microelectronic packaging; U.S. Pat. No. 6,162,849 Zhuo, et al. Thermally conductive thermoplastic; U.S. Pat. No. 6,710,109 McCullough, et al. Thermally conductive and high strength injection moldable composition; U.S. Pat. No. 6,730,731 Tobita, et al. Thermally conductive polymer composition and thermally conductive molded article; U.S. Pat. No. 7,094,822 Sagal, et al. Thermally conductive elastomeric pad).

Fillers such as flaked graphite, chopped carbon fiber, metal powders, metal oxide powders, aluminum nitride, boron nitride among others are described therein. The related art typically includes fillers that are much larger than 100 nm, or are not anisotropic, or processed into fiber systems and textiles that then possessed improved thermal conductivity and thermal stability.

### SUMMARY OF THE INVENTIO

The ability to increase the thermal conductivity of polymeric and composite materials without significantly degrading their mechanical properties offers many potential benefits for current and future thermal control systems in commercial and military applications. Thermal management and heat transfer are critical requirements in all personal protection and life support applications. Frequently, thermal control becomes a major design driver and a limiting factor in the feasibility of textile applications and promising design approaches. This is presently true for protective systems for hazardous materials workers, firefightes and soldiers using protective gear against potential thermal, chemical, biological, and nuclear threats. In these uses, present technology cannot provide the required heat removal capacity within practical limits on system weight and task duration. Heat transport has also had a major influence on spacesuit system design, athletic sportswear and even in patient care. The use of lightweight and comfortable polymeric materials is desirable in all of these systems and improvements expected in the cooling efficiency, temperature homogeneity, comfort factor and lower weight of the unit would substantially improve the quality of life, sustainability, protection and extended job performance.

The vision of the future with thermo-conductive fabrics would involve complete redesign of personal cooling garments. The thermal interfaces are typically sites of high thermal resistance as their contact areas are small. Reducing these barriers along with improved thermal conductivity through this invention's technological advancement will lead to reduction of system infrastructure and reduction in size of the heat expulsion system. It can be envisioned under low load conditions under atmospheric conditions, that the excess heat may be simply vented. This minimizes the current limitations of excessive weight and bulkiness providing a more user-friendly personal cooling system, leading to broader application of its commercial potential.

Based on accepted models for thermal management, there is little question that these materials will have significant strategic potential, generate performance enhancement, and present immediate industrial benefits such as greater thermal conductance and better strength/weight ratio. The composite fiber manufacturing technologies currently in place do not have to be significantly altered, so there will be ready acceptance from both government and civilian composite communities.

The invention has demonstrated: 1) fibers and fabrics show thermal conductivity increases with addition of nanoscale anisotropic materials (NAMs); 2) Thermal conductivity along fiber length is significantly improved (>250%); 3) Final woven fabrics with NAMs show increases of 20-30%; 4) Aligning the NAMs achieves the highest thermal conductivity possible;. 5) Polymer processing is only slightly affected by the presence of small amounts of NAMs., indicating that industrial processing will not be hampered or need to be significantly altered to rapidly produce NAM/polymer masterbatches.

### BRIEF DESCRIPTION OF THE DRAWINGS

FIG. 1 is a scanning electron micrograph image of NanoTex nylon fiber with embedded, oriented carbon nanoscale anisotropic materials.

FIG. 2 is a graph of the thermal conductivity of polymer and various NAM types and loadings.

FIG. 3 is a graph of the thermal conductivity of fabrics constructed from polymer/NAM fibers.

### DETAILED DESCRIPTION OF PREFERRED EMBODIMENTS OF THE INVENTION

The invention applies to any polymer system typically used to produce fibers and has been demonstrated by the inventor in a broad spectrum of systems such as but not limited to: polyamides (Nylon 6, Nylon 6,6′), polyethylene (UHMW), polypropylene, poly-(p-phenyleneterephtalamide)—Kevlar™, spandex fiber and thermoplastic urethanes among others.

The incorporation of nanoscale anisotropic materials covers a broad spectrum of anisotropic materials both laboratory produced and commercially available. Examples include, but not limited to, vapor grown carbon fibers (Pyrograph Products, Inc), carbon nanofibrils (Hyperion Catalysis), single-wall nanotubes (Carbon NanoTechnologies, Inc), carbon anisotropic nanostructures (NanoTex Corp), metallic nanorods (Oxonica, Inc) and various laboratory produced boron nitride, aluminum nitride nanowhiskers under commercial development. The morphology of commercially available NAMs can be altered, for example shortening by chemical methods or mechanical milling to customize viscosity response or dispersion. This is one aspect of the current invention that allows multifunctionality by design in NAM based products. Though different morphologies and chemistries exist with varying physical and electrical properties, of particular relevance to this invention, they all commonly possess high thermal conductivities >1 W/mK, preferably >10 W/mK.

### Mixing of Nanoscale Anisotropic Materials

Mixing of NAM into base polymers can be accomplished by several methods by those skilled the art. Typically loading from 0.1% to 25% can be achieved sufficient to produce a uniform dispersed product covering a wide thermal conductivity range.

By example, thermoplastic fibers such as nylon, polypropylene, etc were processed with twin screw melt compounding. Using the process parameters below with a Werner-Pfleiderer 30 mm Co-rotating Twin Screw compounding extruder various loadings of 1-2 nm carbon NAMs (2-10 wt %) and 100 nm diameter carbon NAM (2-20 wt %) were made. The melt was extruded through a low pressure two hole die. Strands were cooled in a water bath and cut to approximately ¼ inch long pellets.

TABLE 1
Nylon 6,6′ Compounding Conditions

| Condition | | 10% | 20% |
|---|---|---|---|
| Formulation | Setpoint | SWNT | CNF |
| Zone 1 Temp (° C.) | 270 | 258 | 264 |
| Zone 2 Temp (° C.) | 270 | 258 | 267 |
| Zone 3 Temp (° C.) | 270 | 264 | 275 |
| Zone 4 Temp (° C.) | 270 | 266 | 275 |
| Zone 5 Temp (° C.) | 270 | 270 | 275 |
| Die Temp (° C.) | 270 | 275 | 272 |
| Screw Speed (rpm) | | 150 | 150 |
| Torque (%) | | 60 | 58 |
| Die Pressure (psi) | | 160 | 170 |

The resulting products appeared to be uniform with well dispersed NAMs. Compounding was stable with a consistent steady production. The melt compounding was similar for the two nanoscale systems.

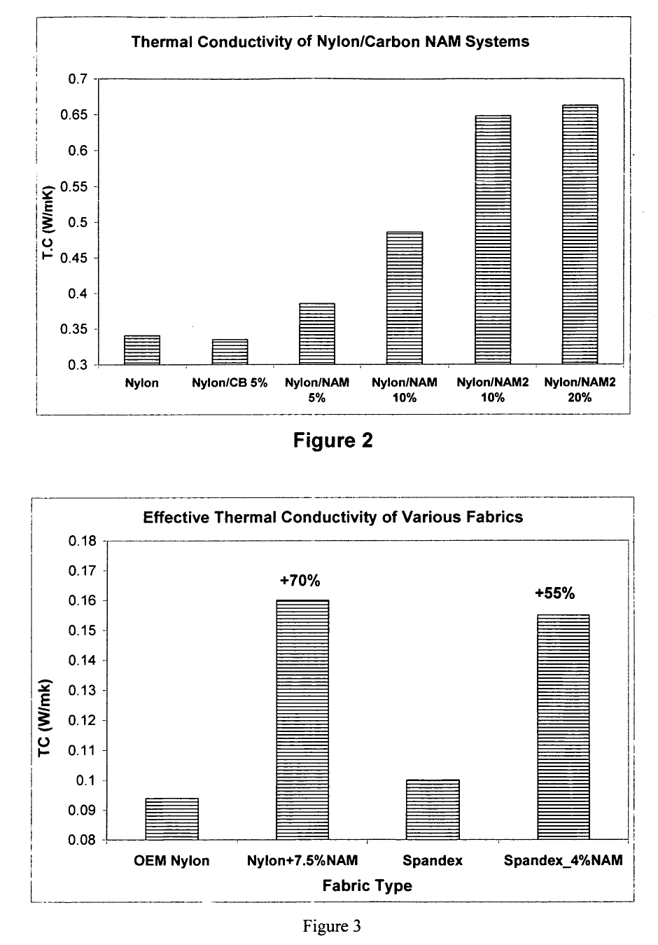

Thermal Conductivity of Nylon Systems: Measurements were made on tensile specimens with the Hot Disk™ Thermal Conductivity apparatus. The results are depicted in FIG. 2.

### Nylon Fiber Production—Melt Spinning

Initial fiber spinning was performed in a ¼ inch screw Microtruder RC 025 CF manufactured by Randcastle Inc.

TABLE 2
Conditions for fiber spinning.

| Condition | Value |
|---|---|
| Feed Zone Temperature (° C.) | 250 |
| CenterZone Temperature (° C.) | 252 |
| End Zone Temperature (° C.) | 285 |
| Die Temperature (° C.) | 288 |

### Dispersion:

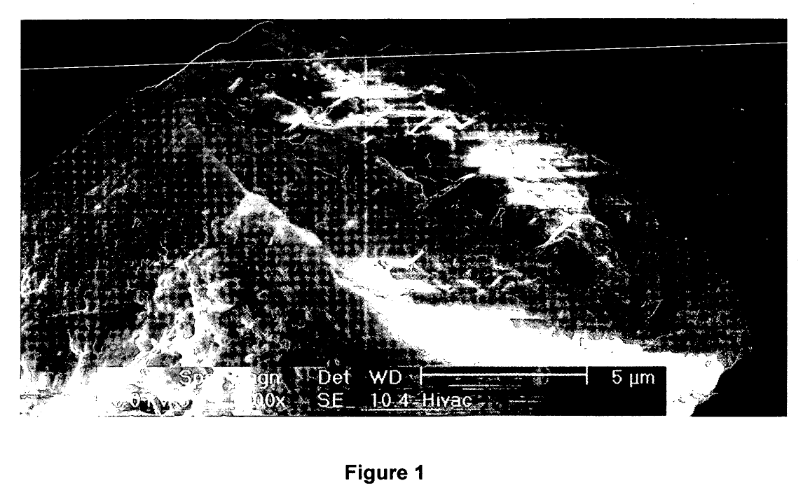

FIG. 1 depicts a scanning electron microscope analysis of a fracture fiber which confirms the uniform dispersion and high degree of alignment of the embedded NAMs at 7.5 wt % loading. The aligned ends of nanoscale fillers are evident in the exposed fiber end.

### Fiber Thermal Testing

Fibers were molded maintaining fiber alignment which allows testing of the resulting block in two directions to determine if any anisotropy in thermal conductivity was created. Using the Hot Disk™ Thermal Conductivity apparatus described previously, the thermal conductivity in the axial and transverse directions were measured.

TABLE 3
Thermal conductivity of Polymer/NAM fibers

| Sample | Thermal Conductivity (W/mK) |
|---|---|
| Transverse | 0.41 |
| Axial | 0.70 |

There is a 75% increase in bulk thermal conductivity of aligned fibers compared to their transverse direction. This is a confirmation of orientation effect.

### Spandex/NAM System

The utility and flexibility of the invention is further demonstrated in an alternate polymer mixing and fiber production technology.

### Suspension Mixing

The two principal polymer chemicals are polytetramethylene ether glycol (PTMEG) of molecular weight around 1500 and methylene bis C4-phenylisocyanate (MDI). The solvent used is dimethyl acetamide (DMAc), with the diamine acts as a chain extender, followed by addition of primary amine to terminate the chain. A fresh polymerization was accomplished to provide new spandex masterbatch to blend with NAMs.

Samples of the various NAMs were dispersed in DMAc at concentrations of 1-10 wt % by mechanical mixing and ultrasonication. A uniform black colloidal suspension was formed which remained stable during a day's period. Preliminary mixing studies with PTMEG solutions showed very good compatibility.

### Fiber Production—Wet Spinning

The process involves predispersion of NAMs in one of the reacting monomers, followed by condensation polymerization. The quality of dispersion was comparable to those of melt compounding. Fiber drawing was done with a wet spinning apparatus. Fibers of various loadings up to ˜7 wt % (limited by viscosity) at various draw ratios were prepared. The fiber quality was good showing smooth surface finish and general uniformity on the take-up winder.

Dispersion evaluation by scanning electron microscopy showed similar qualities as melt compounded nylon masterbatches. At higher magnification, the spandex polymer was observed to wet the NAMs very well.

Fabrics of nylon and spandex and their blends were then warp-knit from the above fibers using a Lawson-Hemphill type sock knitter.

### Effective Thermal Conductivity of Fabrics

An effective thermal conductivity was measured by layering plys of fabric so that a sufficient probing depth could be achieved using the Hot Disk apparatus described above. Measurements were repeated to assure reproducibility. The comparative results between non-filled and NAM-filled fabrics are in FIG. 3.

Overall, NAM composite fibers and fabrics comprising same have the following characteristics:
1) thermal conductivity values that increase with addition of NAM;
2) significantly improved (>250%) thermal conducivity along fiber length;
3) final woven fabrics with NAMs show increases of 55-70% in thermal conductivity over the unfilled fabrics;
4) the highest thermal conductivity is obtained when maximum NAM alignment is achieved;
5) and polymer processing is only slightly affected by the presence of small amounts of NAMs as used in the examples demonstrating the present invention.

This invention allows industrial processing that will not need to be significantly altered to rapidly produce NAM based fibers and fabrics comprised therefrom.

What is claimed is:

1. A polymer fiber composition comprised of a base polymer with a nanoscale anisotropic additive having improved thermal conductivity and thermal stability

2. The fiber compositions of claim 1 wherein the nanoscale anisotropic additives consist of tubular structures with diameters less 500 nm and length-to-diameter ratio greater than 2.

3. The fiber compositions claim 1 wherein the nanoscale anisotropic additives have morphologies that are tubular (nanorods, nanowhiskers, nanowires) or platelets.

4. The fiber compositions of claim 1 wherein the nanoscale anisotropic additives possess heat removal rates greater than 1 W/mK.
